(19) United States
(12) Patent Application Publication
(10) Pub. No.: US 2010/0240340 A1
(43) Pub. Date: Sep. 23, 2010

(54) Emergency Communication Apparatus

(76) Inventor: Issac E. Castleberry, Valdosta, GA (US)

Correspondence Address: HARSHAW RESEARCH, INC., 210 W. TECUMSEH STREET, OTTAWA, KS, 66067, US

(21) Appl. No.: 12/686,440

(22) Filed: Jan. 13, 2010

Related U.S. Application Data
(60) Provisional application No. 61/210,318, filed on Mar. 17, 2009.

(51) Int. Cl. H04M 11/04

(52) U.S. Cl. 455/404.2

(57) ABSTRACT

An emergency communication apparatus includes a user input device having a plurality of provider inputs corresponding to respective emergency service providers and a plurality of severity level inputs corresponding to respective severity levels. The apparatus includes a transmitter for communicating with an emergency response entity, a memory device having owner information, and a GPS device for determining position data. The apparatus includes a processor in data communication with the user input device, transmitter, memory device, and GPS device. The processor includes programming that actuates the transmitter to automatically provide the owner information, the position data, an emergency service provider selected using the user input device, and a severity level selected using the user input device to the emergency response entity.

### REFERENCE TO RELATED APPLICATIONS

This application claims priority to U.S. Provisional Application Ser. No. 61/210,318 filed on Mar. 17, 2009 entitled Panic Phone and Accessories.

### BACKGROUND OF THE INVENTION

This invention relates generally to communication devices and, more particularly, to an emergency communication apparatus that enables a user to communicate directly with a selected emergency service provider and to notify said provider with a selected severity level of an emergency situation.

Most emergency situations are called in by individuals who are either involved in the situation or are witnessing it. If called in to a 9-1-1 operator, the operator immediately tries to determine the nature of the emergency and its severity level so that appropriate emergency service personnel may be dispatched to the scene to provide assistance. Determining the nature of the emergency is sometimes difficult in that the caller may be emotional, excited, or even injured. In addition, a person may not have time or ability to speak to the operator, as may be case when hiding from an intruder, trying to escape an attacker, or being kidnapped.

Various devices have been proposed in the prior art for notifying emergency service providers about an emergency situation, such as with traditional or cell phones. Although assumably effective for their intended purposes, the existing devices and proposals do not enable a user to directly and quickly notify the needed service provider of the nature, severity level, and location of an emergency.

Therefore, it would be desirable to have an emergency communication apparatus that enables a user to input a category of emergency service provider needed and a severity level of the emergency itself. Further, it would be desirable to have an emergency communication apparatus that automatically notifies the selected emergency services provider with the sender's physical location.

### SUMMARY OF THE INVENTION

An emergency communication apparatus includes a user input device having a plurality of provider inputs corresponding to respective emergency service providers and a plurality of severity level inputs corresponding to respective severity levels. The apparatus includes a transmitter for communicating with an emergency response entity, a memory device having owner information, and a GPS device for determining position data. The apparatus includes a processor in data communication with the user input device, transmitter, memory device, and GPS device. The processor includes programming that actuates the transmitter to automatically provide the owner information, the position data, an emergency service provider selected using the user input device, and a severity level selected using the user input device to the emergency response entity.

Therefore, a general object of this invention is to provide an emergency communications apparatus that enables a user to contact an emergency response service with non-spoken indication of a respective emergency service type needed and requested.

Another object of this invention is to provide an emergency communication apparatus, as aforesaid, that also enables a user to communicate a severity level of the emergency to the emergency response service.

Still another object of this invention is to provide an emergency communication apparatus, as aforesaid, that automatically communicates a transmitter's geographic location along with emergency services vendor and severity level data.

Yet another object of this invention is to provide an emergency communication apparatus, as aforesaid, that can initiate two-way communications with an emergency response service.

A further object of this invention is to provide an emergency communication apparatus, as aforesaid, that is easy to use.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an emergency communications apparatus according to one embodiment of the present invention shown in a closed configuration;

FIG. 2a is a perspective view of the apparatus shown in FIG. 1 shown in an open configuration and showing one variation of indicia associated with the provider inputs;

FIG. 2b is another perspective view of the apparatus shown in FIG. 1 shown in an open configuration and showing another variation of indicia associated with the provider inputs;

FIG. 2c is another perspective view of the apparatus shown in FIG. 1 shown in an open configuration and showing another variation of indicia associated with the provider inputs;

FIG. 2d is another perspective view of the apparatus shown in FIG. 1 shown in an open configuration and showing another variation of indicia associated with the provider inputs;

FIG. 3a is an isolated view on an enlarged scale taken from FIG. 2a;

FIG. 3b is an isolated view on an enlarged scale taken from FIG. 2a;

FIG. 4 is a block diagram illustrating the electronic components of the emergency communications apparatus as in claim 2a;

FIG. 5 is a flowchart illustrating the logic performed by processor according to the present invention;

FIG. 6 is a perspective view of the present invention utilizing a housing having another configuration; and

FIG. 7 is a perspective view of the present invention in use with a tether.

### DESCRIPTION OF THE PREFERRED EMBODIMENT

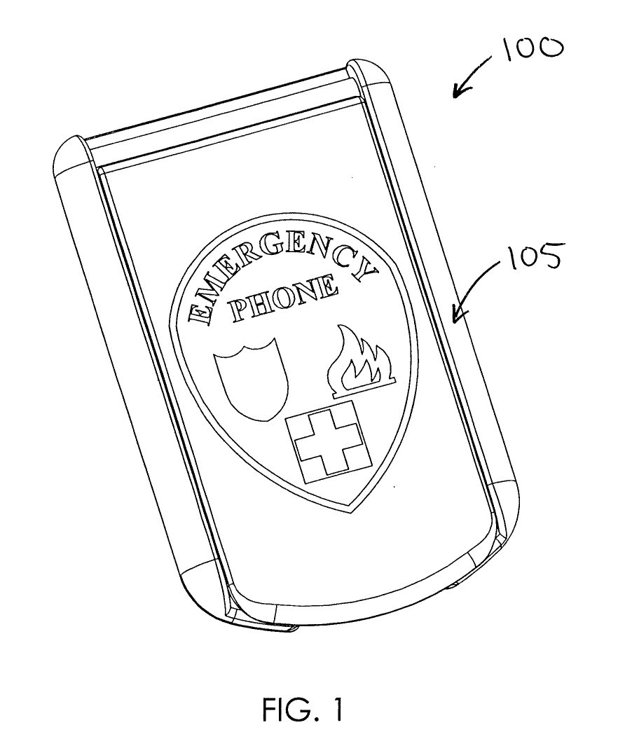

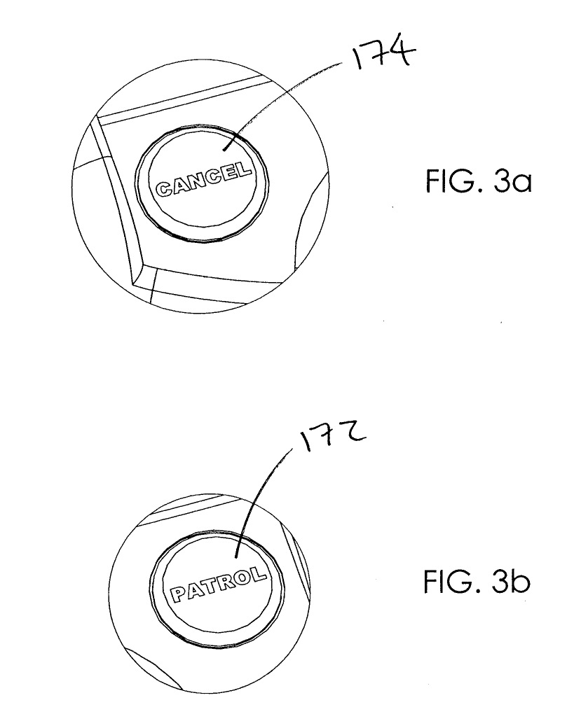

An emergency communication apparatus according to the present invention will now be described in detail with reference to FIGS. 1 through 7 of the accompanying drawings. More particularly, an emergency communication apparatus 100 according to one embodiment includes a processor 110, a user input device 120, a transmitter 130, an electronic memory device 140, and a GPS device 150.

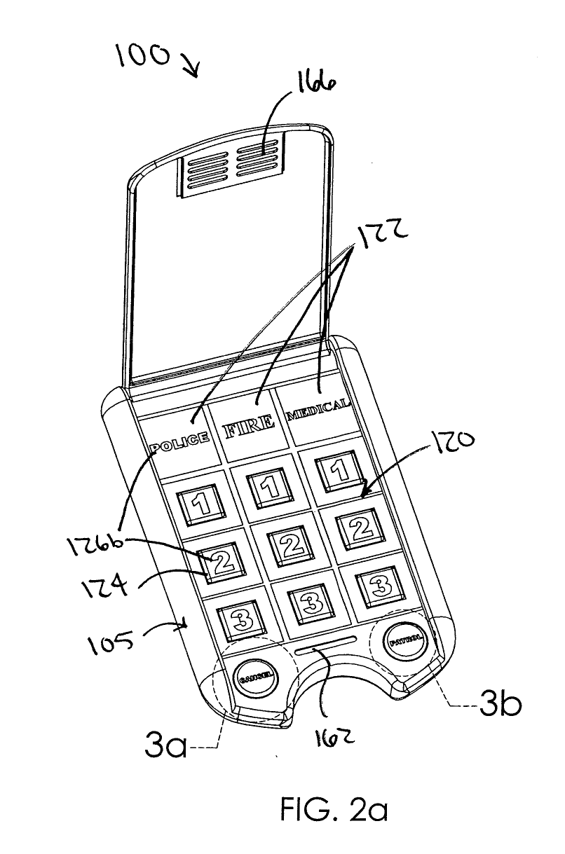

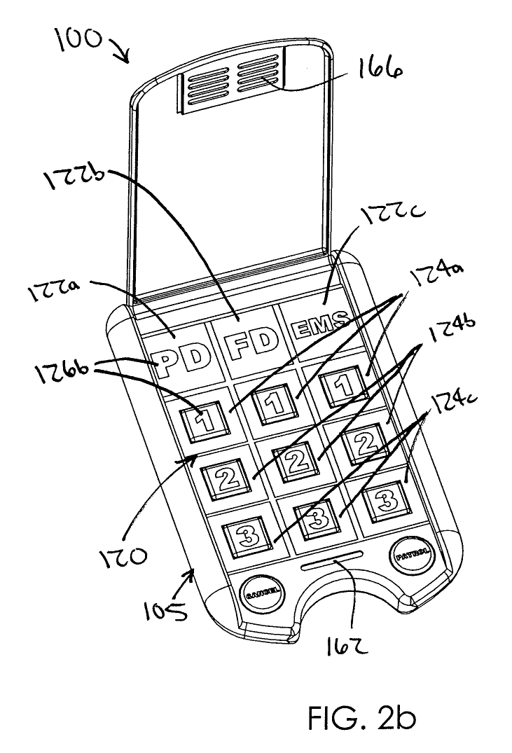

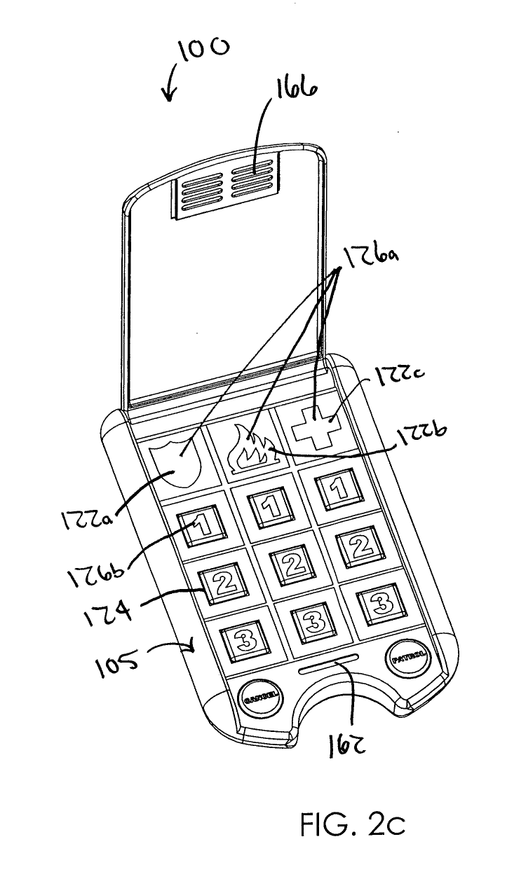

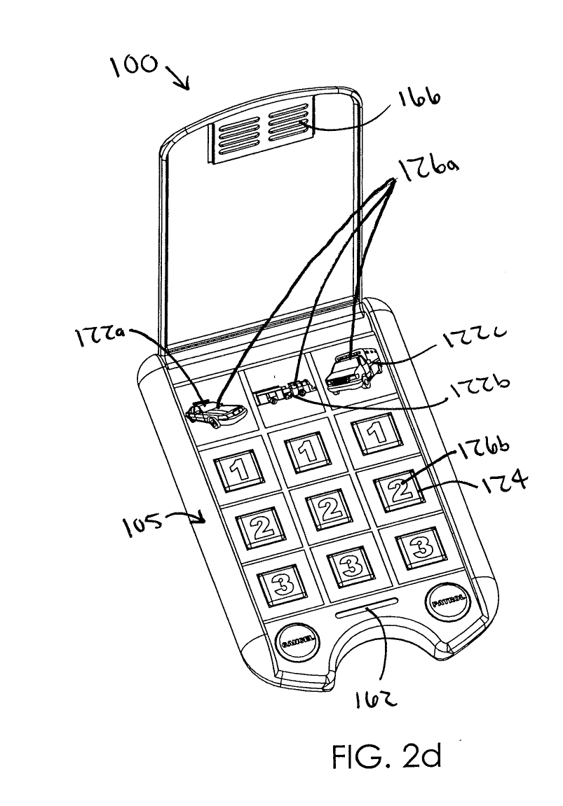

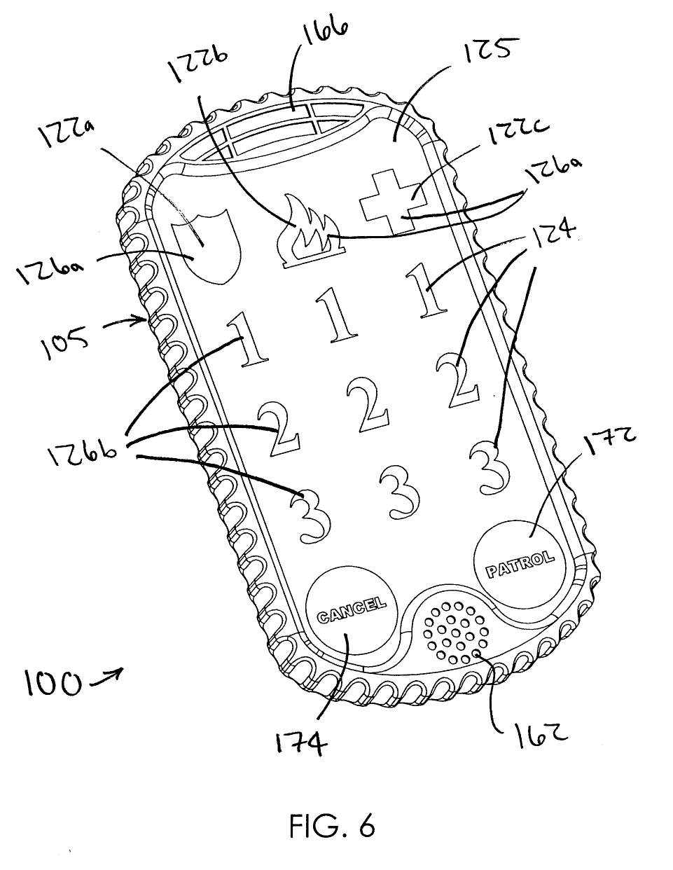

As shown in FIGS. 2a through 2d and FIG. 6, the user input device 120 may include a plurality of provider inputs 122 corresponding to different emergency service providers. For example, one provider input 122a may correspond to a police department, another provider input 122b may correspond to a fire department, and still another provider input 122c may correspond to an emergency medical response. The user input device 120 may also include a plurality of severity level inputs 124 corresponding to different severity levels. For example, one severity level input 124a may correspond to a low severity level, another severity level input 124b may correspond to a medium severity level, and still another severity level input 124c may correspond to a high severity level. As shown in FIGS. 2a through 2d, the provider inputs 122 and the severity level inputs 124 may be buttons. In other embodiments, as shown in FIG. 6, the provider inputs 122 and the severity level inputs 124 may be denoted portions of a touchscreen 125. Moreover, the provider inputs 122 and the severity level inputs 124 may include pictorially-representative indicia 126a (FIGS. 2c, 2d, and 6) and/or alphanumeric indicia 126b (FIGS. 2a through 2d and FIG. 6) that is representative of the emergency service providers and/or the severity levels.

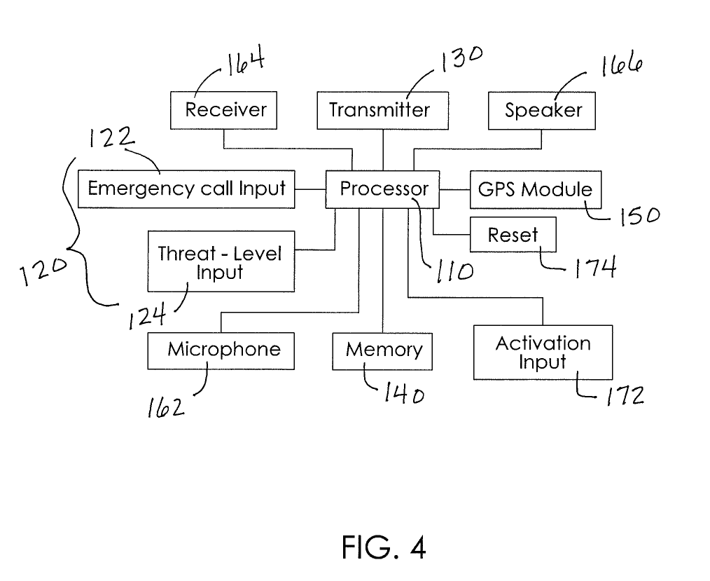

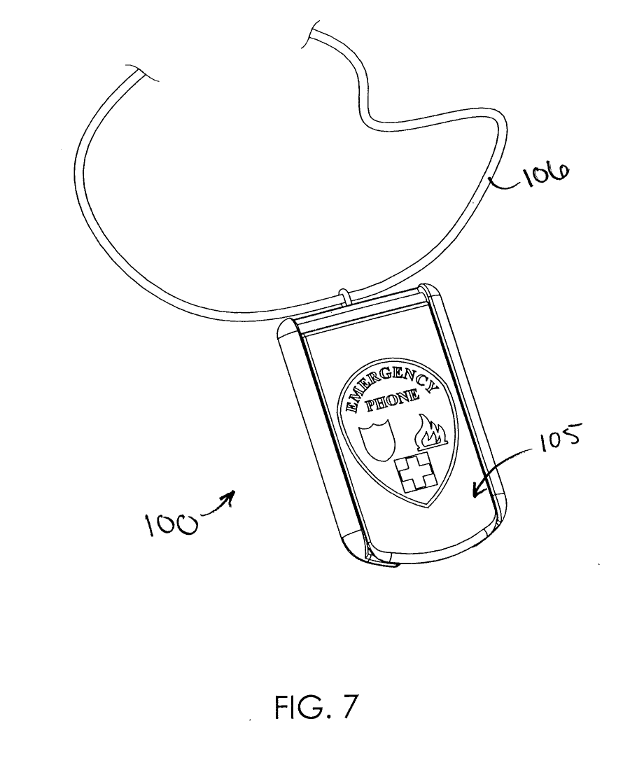

Turning now to FIG. 4, the processor 110 is in data communication with the user input device 120, the transmitter 130, the electronic memory device 140, and the GPS device 150, and all of the elements may be housed in or operatively coupled to a housing 105 (FIG. 1). The transmitter 130 may be, for example, a transmitter that allows communication through a cellular telephone network (e.g., a cell phone transmitter) or a satellite network, or that uses any other acceptable technology, whether now known or later discovered, so long as the transmitter 130 is capable of communicating between the apparatus 100 and an emergency response entity (e.g., a 9-1-1 dispatch center). The electronic memory device 140 may be any appropriate electronic data storage device operable with the processor 110, whether now known or later discovered, as will be appreciated by those skilled in the art. Similarly, the GPS device 150 may be any appropriate Global Positioning System device that determines position data, whether now known or later discovered, as will be appreciated by those skilled in the art. The housing 105 is shown in FIG. 7 to be coupled to a tether 106 (e.g., a necklace or bracelet) and is shown throughout the drawings to be configured similar to a cellular telephone housing. It should be appreciated, however, that an almost unlimited number of different configurations for the housing 105 are possible.

The electronic memory device 140 has owner information stored therein, which may include, for example, the owner's name, address, emergency contact information, gender, race, age, eye color, height, weight, and/or medical history. Means for inputting the owner information to the electronic memory device 140 may accordingly be provided. For example, a microphone 162 (FIGS. 2a through 2d, FIG. 4, and FIG. 6), an alphanumeric input device, and/or a port allowing communication between the electronic memory device and an external apparatus (e.g., a computer, keyboard, etc.) may be in data communication with the processor 110.

In some embodiments, as shown in FIG. 4, the processor 110 may also be in data communication with a receiver 164 for communicating with the emergency response entity, a speaker 166, means for actuating the processor 110 (e.g., an activation input 172 accessible by the user), and a cancelation input 174 accessible by the user.

The processor 110 may include programming that actuates the transmitter 130 to automatically (i.e., without further human intervention) provide the owner information, the position data, an emergency service provider (selected using the input device 120), and a severity level (selected using the input device 120) to the emergency response entity. The programming may actuate the transmitter 130 to communicate with the emergency response entity only upon selection of a respective emergency service provider and a respective severity level, and the programming may also actuate the receiver 164 and the speaker 166 for communication with the emergency response entity after selection of a respective emergency service provider and a respective severity level. Upon the processor 110 receiving data from the cancelation input 174, programming may actuate the transmitter 130 to automatically provide a cancelation signal to the emergency response entity. In some embodiments, the transmitter 130 may continue providing various data (e.g., the position data) to the emergency response entity until the processor 110 receives (e.g., via the receiver 164) a reset signal from the emergency response entity. The processor 110 may be a cell phone processor, and the programming may be an application executable by the processor 110, or the processor 110 may be any other appropriate processing device, whether now known or later developed, as will be appreciated by those skilled in the art.

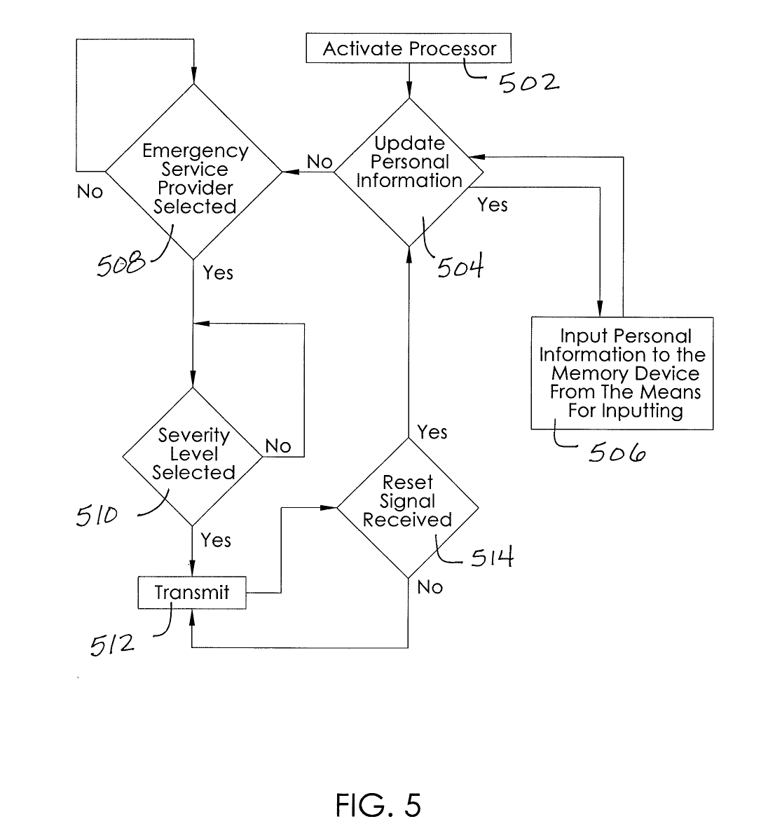

FIG. 5 shows a process 500 of the emergency communication apparatus 100 in use according to one embodiment. The process 500 begins at step 502, when the processor 110 is activated using the activation input 172, and the process 500 continues to step 504. At step 504, the processor 110 determines whether the user wants to update the personal (or “owner”) information. This decision may be based on input from the user (e.g., input from the microphone 162, the port, etc.). If so, the process 500 proceeds to step 506; if not, the process 500 proceeds to step 508.

At step 506, the processor 110 inputs personal information received from the microphone 162, the port, etc., to the memory device 140, and the memory device 140 stores the personal information. The process 500 then returns to step 504.

At step 508, the processor 110 determines whether an emergency service provider has been selected using the provider inputs 122. If so, the process continues to step 510.

At step 510, the processor 110 determines whether a severity level has been selected using the severity level inputs 124. If so, the process continues to step 512.

At step 512, the processor 110 actuates the transmitter 130 to transmit various information to the emergency response entity, including the stored personal information, the emergency service provider that was selected at step 508, the severity level that was selected at step 510, and the position data from the GPS device 150. The processor 110 may also cause the transmitter 130 to transmit data from the microphone 162, and may cause the receiver 164 and the speaker 166, respectively, to receive and convey information from the emergency response entity. As, in some emergencies, it may be beneficial for the speaker 166 to remain silent, activation of the speaker 166 may require additional input from the user. Nevertheless, the transmission of the various information occurs automatically upon selection of the emergency service provider and the severity level.

If the processor 110 receives a reset signal (e.g., at step 514), the process 500 may return to step 504, for example. In some embodiments, the reset signal may be a signal from the cancelation input 174. In other embodiments, the reset signal may be a signal from the emergency response entity which is sent after the cancelation input 174 is activated and the emergency response entity is satisfied that an emergency response is not needed.

It is understood that while certain forms of this invention have been illustrated and described, it is not limited thereto except insofar as such limitations are included in the following claims and allowable functional equivalents thereof.

1. An emergency communication apparatus, comprising:
a user input device comprising:
(a) a plurality of provider inputs corresponding to respective ones of a plurality of emergency service providers; and
(b) a plurality of severity level inputs corresponding to respective ones of a plurality of severity levels;
a transmitter for communicating with an emergency response entity;
an electronic memory device having owner information stored therein;
a GPS device determining position data; and
a processor in data communication with said user input device, said transmitter, said electronic memory device, and said GPS device; said processor having programming that actuates said transmitter to automatically provide said owner information, said position data, an emergency service provider selected using said user input device, and a severity level selected using said user input device to said emergency response entity; said programming only actuating said transmitter for communication with said emergency response entity upon selection of a respective emergency service provider and a respective severity level.

2. The emergency communication apparatus of claim 1, further comprising means for inputting said owner information to said electronic memory device.

3. The emergency communication apparatus of claim 2, wherein said means for inputting includes at least one item selected from the group consisting of:
a microphone;
an alphanumeric input device; and
a port in data communication with said electronic memory device for allowing communication between said electronic memory device and an external apparatus.

4. The emergency communication apparatus of claim 2, further comprising:
a receiver in data communication with said processor for communicating with said emergency response entity;
a microphone in data communication with said processor; and
a speaker in data communication with said processor.

5. The emergency communication apparatus of claim 4, wherein said processor has programming that only actuates at least one of said receiver and said speaker for communication with said emergency response entity after said selection of a respective emergency service provider and said selection of a respective severity level.

6. The emergency communication apparatus of claim 5, further comprising means for actuating said processor.

7. The emergency communication apparatus of claim 6, wherein:
said user input device includes a cancelation input; and
said processor has programming that actuates said transmitter to automatically provide a cancelation signal to said emergency response entity upon said processor receiving data from said cancelation input.

8. The emergency communication apparatus of claim 7, wherein:
said processor is a cell phone processor;
said transmitter is a cell phone transmitter;
said provider inputs are denoted portions of a touchscreen; and
said severity level inputs are denoted portions of a touchscreen.

9. The emergency communication apparatus of claim 7, wherein said provider inputs are buttons, and wherein said severity level inputs are buttons.

10. The emergency communication apparatus of claim 7, wherein said owner information comprises: owner name; owner address; emergency contact information; owner gender; owner race; owner age; owner eye color; owner height; owner weight; and owner medical history.

11. The emergency communication apparatus of claim 7, wherein said provider inputs include indicia selected from pictorially-representative indicia and alphanumeric indicia, and wherein said severity level inputs include indicia selected from pictorially-representative indicia and alphanumeric indicia.

12. The emergency communication apparatus of claim 1, wherein:
said processor is a cell phone processor;
said transmitter is a cell phone transmitter;
said provider inputs are denoted portions of a touchscreen; and
said severity level inputs are denoted portions of a touchscreen.
